(19) United States
(12) Patent Application Publication
(10) Pub. No.: US 2015/0101355 A1
(43) Pub. Date: Apr. 16, 2015

(54) AIR CONDITIONING SYSTEM AND METHOD FOR HIGH-VOLTAGE BATTERY OF VEHICLE

(71) Applicant: Hyundai Motor Company, Seoul (KR)

(72) Inventors: Man Ju Oh, Gyeonggi-do (KR); Jae Woong Kim, Gyeonggi-do (KR); Jae Woo Park, Gyeonggi-do (KR); Jae Hoon Kim, Chungcheongnam-do (KR)

(73) Assignee: Hyundai Motor Company, Seoul (KR)

(21) Appl. No.: 14/143,668

(22) Filed: Dec. 30, 2013

(30) Foreign Application Priority Data
Oct. 10, 2013 (KR) 10-2013-0120829

(51) Int. Cl. H01M 10/6572; H01M 10/625; H01M 10/613; H01M 10/615; F25B 21/04; B60H 1/00

(52) U.S. Cl. CPC H01M 10/5085; F25B 21/04; B60H 1/00478; H01M 10/5004; H01M 10/5006; H01M 10/5016; F25B 2321/021
USPC 62/3.3; 62/3.2

(57) ABSTRACT

Air conditioning system and method for a high-voltage battery of a vehicle are provided. The system includes a first heat exchanger that is disposed within a battery housing and a first blower that supplies air to the first heat exchanger. A peltier element is combined with the first heat exchanger and a first surface of the peltier element comes into contact with the first heat exchanger. A second heat exchanger is disposed in an air extraction unit of a trunk room and a second blower supplies air to the second heat exchanger, to discharge air inside the trunk room to an exterior after performing heat exchange. A cooling line operates as a coolant circulating line, and a first end of the cooling line comes into contact with a second surface of the peltier element and a second end performs heat exchange between the second end and the second heat exchanger.

### BACKGROUND

1. Field of the Invention

The present invention relates to an air conditioning system and method for a high-voltage battery of a vehicle, which efficiently increases or decreases the temperature of a high-voltage battery of an electric motor vehicle or of a hybrid vehicle, to maintain an optimal operational state of the high-voltage battery.

2. Description of the Related Art

To drive an environmentally friendly vehicle, such as an electric motor vehicle, a hybrid vehicle and a fuel cell vehicle, a motor or a high-voltage battery is used. However, in the conventional high-voltage battery when the battery is electrically charged, the battery may overheat. Further, when using the battery during winter, the battery may wear more rapidly. Accordingly, the battery may not provide the original performance and may deteriorate.

In the related art, most proposed techniques of air-conditioning high-voltage batteries of vehicles use air conditioning systems using a conventional coolant to cool the batteries, in which the high-voltage battery is cooled using convection currents of cold passenger compartment air that has been forcibly drawn to the battery. However, these techniques undesirably increase the passenger compartment cooling load, and furthermore, when the passenger compartment is being cooled, the known techniques may not desirably cool the battery.

Furthermore, in the related art, a battery cooling and heating system designed to cool and heat a high-voltage battery using a peltier element (e.g., thermoelectric element) has been developed, in which a peltier heat exchanger is mounted to a surface of the high-voltage battery. In addition, fins are disposed on the outer surface of the battery to dissipate heat from the battery to air. However, in this battery cooling and heating system, the system dissipates waste heat of the battery to air, causing structural defects to the system since it is an air to air system that may undesirably reduce the heat dissipating performance of the battery cooling/heating system.

The foregoing is intended merely to aid in the understanding of the background of the present invention, and is not intended to mean that the present invention falls within the purview of the related art that is already known to those skilled in the art.

### SUMMARY

Accordingly, the present invention provides an air conditioning system and method for a high-voltage battery of a vehicle, which may dissipate heat of a peltier element more efficiently without using hot and cold air of a passenger compartment, thus, performing an air conditioning operation for the high-voltage battery more efficiently.

According to one aspect of the present invention, an air conditioning system for a high-voltage battery of a vehicle may include: a first heat exchanger disposed within a battery housing, and a first blower configured to supply air to the first heat exchanger at a position next to the first heat exchanger; a peltier element combined with the first heat exchanger to cause a first surface of the peltier element to contact the first heat exchanger; a second heat exchanger disposed within an air extraction unit of a trunk room, and a second blower configured to supply air to the second heat exchanger at a position next to the second heat exchanger, to discharge air inside the trunk room to the exterior after performing heat exchange between the air inside the trunk room and the second heat exchanger; and a cooling line that operates as a coolant circulating line, wherein a first end of the cooling line may come into contact with a second surface of the peltier element and a second end of the cooling line may be configured to perform heat exchange between the second end and the second heat exchanger.

The battery housing may have a sealed structure, and the first heat exchanger, the first blower and the peltier element may be disposed inside the battery housing to adjust air inside the battery housing, wherein the first end of the cooling line may be inserted into the battery housing, and may be combined with the peltier element inside the battery housing. The second heat exchanger may be disposed inside the trunk room at a location next to the air extraction unit, and the second blower may be disposed at a location in back of the second heat exchanger and may be configured to blow the air inside the trunk room to the second heat exchanger.

Furthermore, the cooling line may include a hydraulic pump to circulate a coolant through the cooling line. The battery housing may be installed in a front part inside the trunk room, and the air extraction unit may be installed in a side part of the trunk room. Each of the first heat exchanger and the second heat exchanger may include a plurality of heat dissipating fins, to allow heat exchange to be performed between the fins and air.

The air conditioning system may further include: a controller configured to operate the first blower, the second blower, the peltier element and the cooling line. In particular, when the high-voltage battery is to be cooled using a low stage cooling mode, the controller may be configured to operate the cooling line and the first blower. When the high-voltage battery is to be cooled using a high stage cooling mode, the controller may be configured to operate the first blower, the second blower, the peltier element and the cooling line. When the high-voltage battery is to be heated, the peltier element may be operated by the controller to emit heat from the first surface of the peltier element, and the first blower may be operated.

In another aspect, the present invention provides an air conditioning method for a high-voltage battery of a vehicle, the method being performed using the air conditioning system. The method may include: selecting, by the controller, an operational mode required by the high-voltage battery; and performing, by the controller, a high stage cooling operation when a high stage cooling mode has been selected, in which both the first blower and the second blower are activated, the peltier element may be configured to cool the first surface of the peltier element, and the coolant may be circulated through the cooling line.

The air conditioning method may further include: performing, by the controller, a low stage cooling operation, in which the coolant may be circulated through the cooling line and the first blower may be activated, when a low stage cooling mode has been selected. Further, the method may include: performing, by a controller, a heating operation, in which the peltier element may be configured to emit heat from the first surface of the peltier element, and the first blower may be activated when a heating mode has been selected. In the air conditioning system and method for the high-voltage battery of the vehicle according to the present invention, heat of the peltier element may be dissipated more efficiently without using hot and cold air of a passenger compartment, thus allowing the present invention perform an air conditioning operation for the high-voltage battery more efficiently.

In addition, the present invention is designed to dissipate waste heat of the peltier element using a water-cooling technique, to improve the operational performance of the air conditioning system compared to air conditioning systems using an air-cooling technique of the related art (e.g., the water-cooling technique may improve the heat dissipating performance two to five times compared to the air-cooling technique of the related art). Further, in the present invention, an outside radiator may be installed next to a conventional air extraction outlet discharges passenger compartment air, allowing heat exchange to be performed using naturally circulated air during a normal driving mode of the vehicle, thereby desirably using minimal energy. In addition, the present invention does not use cold passenger compartment air, thus reducing the cooling load of an original air conditioner of the vehicle which functions to control passenger compartment air.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is an exemplary view illustrating an air conditioning system for a high-voltage battery of a vehicle according to an exemplary embodiment of the present invention; and

FIGS. 2 to 4 are exemplary views illustrating the operation of the air conditioning system for the high-voltage battery of the vehicle according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

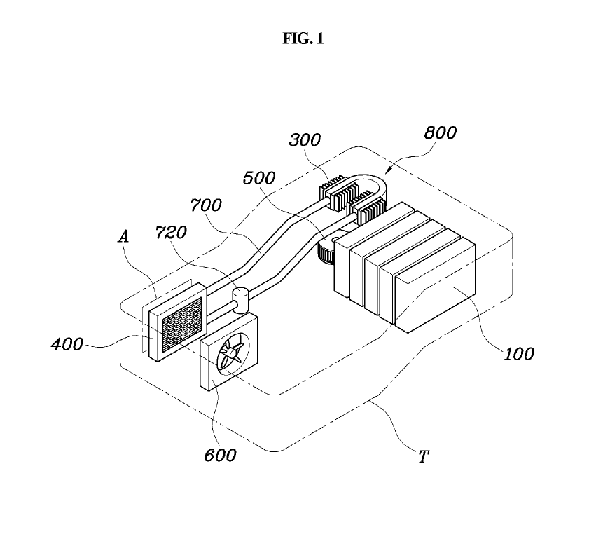

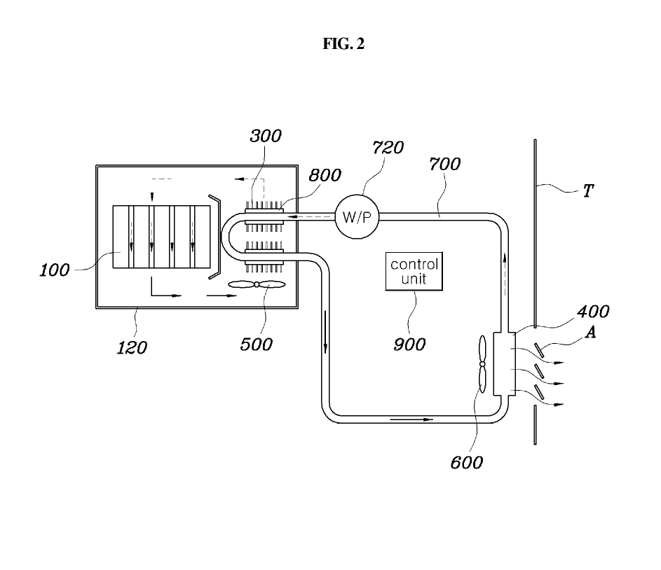

Hereinbelow, exemplary embodiments of air conditioning system and method for a high-voltage battery of a vehicle according to the present invention will be described in detail with reference to the accompanying drawings. FIG. 1 is an exemplary view illustrating an air conditioning system for a high-voltage battery of a vehicle according to an exemplary embodiment of the present invention. FIGS. 2 to 4 are exemplary views illustrating the operation of the air conditioning system for the high- voltage battery of the vehicle according to an exemplary embodiment of the present invention.

As shown in FIG. 1, the air conditioning system for the high-voltage battery of the vehicle may include: a first heat exchanger 300 disposed within a battery housing 120, and a first blower 500 configured to supply air to the first heat exchanger 300 at a position substantially next to the first heat exchanger 300; a peltier element 800 combined with the first heat exchanger 300 wherein a first surface of the peltier element 800 may come into contact with (e.g., may touch, connect, etc.) the first heat exchanger 300; a second heat exchanger 400 indisposed within an air extraction unit A of a trunk room T, and a second blower 600 configured to supply air to the second heat exchanger 400 at a position substantially next to the second heat exchanger 400, to discharge air within the trunk room T to the atmosphere (e.g., to the exterior) after performing heat exchange between the air within the trunk room T and the second heat exchanger 400; and a cooling line 700 that may operate as a coolant circulating line, wherein a first end of the cooling line arranged may come into contact with a second surface of the peltier element 800 and a second end of the cooling line may be configured to perform heat exchange between the second end of the cooling line and the second heat exchanger 400.

The system and method of the present invention may be configured to perform air-conditioning for a high-voltage battery of an environmentally friendly vehicle, and perform the air-conditioning in the housing 120 in which the high-voltage battery 100 is installed. The first heat exchanger 300 and the first blower 500 that may be configured to supply air to the first heat exchanger 300 may be disposed within the battery 120. Therefore, air inside the housing 120 may be circulated by the first blower 500 and heat exchange may be performed between the air and the first heat exchanger 300, thereby conditioning the air. In particular, the peltier element 800 may be a thermoelectric element, in which, when a first surface of the peltier element is cooled in response to an application of electricity thereto, a second surface may be heated, and, when the first surface is heated by electricity, the second surface may be cooled. The peltier element 800 may be disposed within the housing 120 causing the first surface to come into contact with the first heat exchanger 300.

Further, in a vehicle, it is typical that an air extraction unit A is disposed on a side surface of the trunk room T to discharge air from the vehicle to the atmosphere (e.g., exterior). The air extraction unit A may include an air extraction passageway (e.g., aperture) open in a direction toward the exterior, and a grill combined with the air extraction passageway. Thus, air inside the vehicle may be primarily exhausted to the trunk room, and may then be discharged from the trunk room to the atmosphere via the air extraction unit. The second heat exchanger 400 may be disposed within the air extraction unit A. Further, the second blower 600 may be disposed within the air extraction unit A and the second blower 600 may be configured to supply pressurized air to the second heat exchanger 400 to discharge the air inside the trunk room T to the exterior after heat exchange has been performed between the air inside the trunk room and the second heat exchanger 400.

In addition, the cooling line 700 may be configured to operate as a coolant circulating line wherein the first end of the cooling line may come into contact with the second surface of the peltier element 800, and the second end of the cooling line may be configured to perform heat exchange between the second end of the cooling line and the second heat exchanger 400. Thus, briefly described, the present invention may be configured to dissipate heat of the peltier element 800 using a water- cooling technique, and dissipate waste heat of the second heat exchanger 400 that operates as a radiator to the exterior via the air extraction unit A.

Due to the above-mentioned construction, the present invention may dissipate heat of the peltier element, which is an independent element, more efficiently without using hot and cold air of a passenger compartment, and thus, the present invention may perform an air conditioning operation for the high-voltage battery more efficiently. Further, since the present invention may eliminate the use of cold passenger compartment air, the invention may reduce the cooling load of the air conditioner of the vehicle which controls passenger compartment air. In addition, the present invention may be designed to dissipate waste heat of the peltier element using a water-cooling technique, to improve the operational performance of the air conditioning system compared to air conditioning systems using an air-cooling technique (e.g., the water-cooling technique may improve the heat dissipating performance two to five times compared to the air-cooling technique of the related art).

In the present invention, the battery housing 120 may have a sealed structure, and the first heat exchanger 300, the first blower 500 and the peltier element 800 may be disposed inside the housing 120 to control the air inside the housing 120. Further, the first end of the cooling line 700 may be inserted into the housing 120 to be combined with the peltier element 800 inside the housing 120. Due to the sealed structure of the housing 120, the present invention may use minimal electricity (e.g., reduced electricity) and may improve the operational effect for air-conditioning the battery. Further, the second heat exchanger 400 may be disposed inside the trunk room T at a location substantially next to the air extraction unit A, and the second blower 600 may be disposed at a location in back of the second heat exchanger 400 to blow the air inside the trunk room T to the second heat exchanger 400. In addition, the cooling line 700 may include a hydraulic pump 720 to circulate a coolant through the cooling line 700.

In addition, the battery housing 120 may be installed in a front part inside the trunk room T, and the air extraction unit A may be installed in a side part of the trunk room T. Due to this arrangement, the present invention may use the air inside the trunk room T more efficiently and may improve the operational performance of the second heat exchanger 400 operating as a radiator. In particular, each of the first heat exchanger 300 and the second heat exchanger 400 may include a plurality of heat dissipating fins, to allow heat exchange to be performed between the fins and blown air.

The air conditioning system for the high-voltage battery of the vehicle may further include a controller 900 configured to operate the first blower 500, the second blower 600, the peltier element 800 and the cooling line 700. The high-voltage battery 100 may require to be slightly cooled, strongly cooled (e.g., may be cooled at different levels such as a low level and a high level of predetermined cooling settings) or may be heated according to a state of the battery. Therefore, when it is required to slightly cool the battery 100 using a low stage cooling mode, the controller 900 may be configured to activate both the first blower 500 and the cooling line 700, as shown in FIG. 2.

In other words, the controller 900 may be configured to operate the first blower 500 while circulating the coolant to perform natural heat exchange. The low stage cooling mode may be used during a normal driving mode of the vehicle (e.g., when the battery is not overheated). During the low stage cooling mode, the peltier element 800 may not be operated, allowing efficient reduction of energy consumption. In particular, in the present invention, the second heat exchanger 400 may be installed at a location substantially next to the air extraction unit A, allowing heat exchange of the high-voltage battery to be performed using naturally circulated air during the normal driving mode of the vehicle, thereby efficiently saving energy.

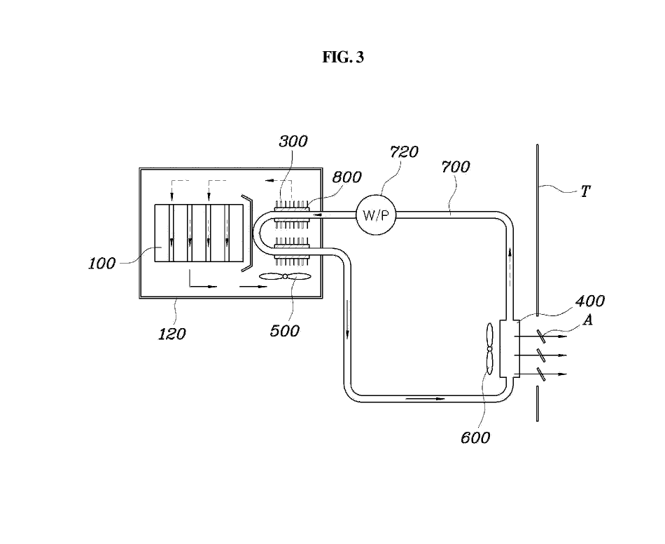

Further, when it is required to strongly cool the high-voltage battery 100 using a high stage cooling mode, the controller 900 may be configured to operate all of the first blower 500, the second blower 600, the peltier element 800 and the cooling line 700, as shown in FIG. 3. In the high stage cooling mode, the controller 900 may be configured to operate the peltier element 800 to start a cooling mode of the peltier element 800, thus operating all the elements associated with the peltier element 800.

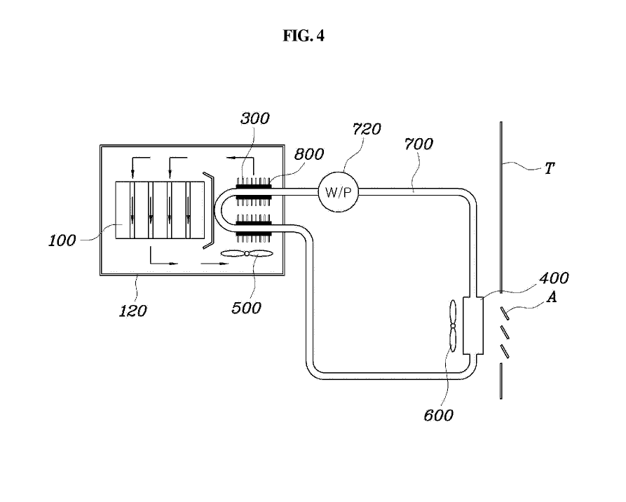

Additionally, when it is required to heat the high-voltage battery 100, the controller 900 may be configured to operate the peltier element 800 to emit heat from the first surface of the peltier element 800, and may be configured to operate the first blower 500, as shown in FIG. 4. In other words, in a battery heating mode, the peltier element 800 may be configured to generate heat from the first surface of the peltier element. However, during the battery heating mode, the controller 900 may be configured to operate only the first blower 500 without operating the second blower 600 inside the battery housing 120, thus performing the battery heating mode without dissipating heat from the peltier element 800.

Moreover, the air conditioning method for the high-voltage battery of the vehicle using the above-mentioned air conditioning system may include: selecting, by a controller, an operational mode required by the high-voltage battery; and performing, by the controller, a high stage cooling operation of the system when a high stage cooling mode has been selected, in which the controller may be configured to activate both the first blower and the second blower, operate the peltier element to cool the first surface of the peltier element, and circulate the coolant through the cooling line. In other words, to air-condition the high voltage battery of the vehicle, one of the low stage cooling mode, the high stage cooling mode and the heating mode may be primarily selected. Then, when the high stage cooling mode has been selected, both the first blower 500 and the second blower 600 may be activated, the peltier element 800 may be operated to cool the first surface of the element, and the coolant may be circulated through the cooling line 700.

Further, when the low stage cooling mode has been selected, the controller 900 may be configured to perform a low stage cooling operation, in which the coolant may be circulated through the cooling line 700 and the first blower 500 may be activated, as shown in FIG. 2. When the heating mode has been selected, the controller 900 may be configured to perform a heating operation, in which the peltier element 800 may be operated to emit heat from the first surface of the peltier element 800, and the first blower 500 may be activated, as shown in FIG. 4.

In the air conditioning system and method for the high-voltage battery of the vehicle according to the exemplary embodiment of the present invention, heat of the peltier element may be dissipated more efficiently without using hot and cold air of a passenger compartment, thus the present invention may perform an air conditioning operation for the high-voltage battery more efficiently. In addition, the present invention may be designed to dissipate waste heat of the peltier element using a water-cooling technique, to improve the operational performance of the air conditioning system compared to air conditioning systems using an air-cooling technique (e.g., the water-cooling technique may improve the heat dissipating performance two to five times compared to the air-cooling technique of the related art).

Furthermore, in the present invention, an outside radiator may be installed at a location substantially next to a conventional air extraction aperture that may be configured to discharge passenger compartment air, to allow heat exchange to be performed using naturally circulated air during a normal driving mode of the vehicle, thereby desirably using minimal energy. In addition, the present invention may eliminate the use of cold passenger compartment air, thus reducing the cooling load of the primary air conditioner of the vehicle which functions to control passenger compartment air.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An air conditioning system for a voltage battery of a vehicle, comprising:
a first heat exchanger disposed within a battery housing;
a first blower configured to supply air to the first heat exchanger and disposed at a position next to the first heat exchanger;
a peltier element combined with the first heat exchanger, wherein a first surface of the peltier element comes into contact with the first heat exchanger;
a second heat exchanger disposed within an air extraction unit of a trunk room;
a second blower configured to supply air to the second heat exchanger and disposed at a position next to the second heat exchanger, to discharge air inside the trunk room to an exterior after performing heat exchange between the air inside the trunk room and the second heat exchanger; and
a cooling line configured to operate as a coolant circulating line, wherein a first end of the cooling line comes into contact with a second surface of the peltier element and a second end of the cooling line is configured to perform heat exchange between the second end of the cooling line and the second heat exchanger.

2. The air conditioning system for the voltage battery of the vehicle as set forth in claim 1, wherein the battery housing has a sealed structure, and the first heat exchanger, the first blower and the peltier element are disposed inside the battery housing to control air inside the battery housing, wherein the first end of the cooling line is inserted into the battery housing, and is combined with the peltier element inside the battery housing.

3. The air conditioning system for the voltage battery of the vehicle as set forth in claim 1, wherein the second heat exchanger is disposed inside the trunk room next to the air extraction unit, and the second blower is disposed in a back of the second heat exchanger and is configured to blow the air inside the trunk room to the second heat exchanger.

4. The air conditioning system for the voltage battery of the vehicle as set forth in claim 1, wherein the cooling line includes a hydraulic pump to circulate a coolant through the cooling line.

5. The air conditioning system for the voltage battery of the vehicle as set forth in claim 1, wherein the battery housing is installed in a front part within the trunk room, and the air extraction unit is installed in a side part of the trunk room.

6. The air conditioning system for the voltage battery of the vehicle as set forth in claim 1, wherein each of the first heat exchanger and the second heat exchanger includes a plurality of heat dissipating fins to allow heat exchange to be performed between the fins and air.

7. The air conditioning system for the voltage battery of the vehicle as set forth in claim 1, further comprising:
a controller configured to operate the first blower, the second blower, the peltier element and the cooling line.

8. The air conditioning system for the voltage battery of the vehicle as set forth in claim 7, wherein, when the voltage battery is to be cooled using a low stage cooling mode, the controller is configured to operate the cooling line and the first blower.

9. The air conditioning system for the voltage battery of the vehicle as set forth in claim 7, wherein, when the voltage battery is to be cooled using a high stage cooling mode, the controller is configured to operate the first blower, the second blower, the peltier element, and the cooling line.

10. The air conditioning system for the voltage battery of the vehicle as set forth in claim 7, wherein, when the voltage battery is to be heated, the controller is configured to operate the peltier element to emit heat from the first surface of the peltier element, and to operate the first blower.

11. An air conditioning method for a voltage battery of a vehicle, the method being performed using the air conditioning system of claim 7, the method comprising:
selecting, by the controller, an operational mode required by the voltage battery; and
performing, by the controller, a high stage cooling operation when a high stage cooling mode has been selected, in which both the first blower and the second blower are activated, the peltier element is operated to cool the first surface of the peltier element, and the coolant is circulated through the cooling line.

12. The air conditioning method for the voltage battery of the vehicle as set forth in claim 11, further comprising:
performing, by the controller, a low stage cooling operation, in which the coolant is circulated through the cooling line and the first blower is activated, when a low stage cooling mode has been selected.

13. The air conditioning method for the voltage battery of the vehicle as set forth in claim 11, further comprising:
performing, by the controller, a heating operation, in which the peltier element is operated to emit heat from the first surface of the peltier element, and the first blower is activated, when a heating mode has been selected.

14. A non-transitory computer readable medium containing program instructions executed by a controller, the computer readable medium comprising:
program instructions that select an operational mode required by a voltage battery; and
program instructions that perform a high stage cooling operation when a high stage cooling mode has been selected, in which both a first blower and a second blower are activated, a peltier element is operated to cool a first surface of the peltier element, and a coolant is circulated through a cooling line.

15. The non-transitory computer readable medium of claim 14, wherein:
a first heat exchanger is disposed within a battery housing;
the first blower is configured to supply air to the first heat exchanger and is disposed at a position next to the first heat exchanger;
the peltier element is combined with the first heat exchanger, wherein the first surface of the peltier element comes into contact with the first heat exchanger;
a second heat exchanger is disposed within an air extraction unit of a trunk room;
the second blower is configured to supply air to the second heat exchanger and is disposed at a position next to the second heat exchanger, to discharge air inside the trunk room to an exterior after performing heat exchange between the air inside the trunk room and the second heat exchanger; and
the cooling line is configured to operate as a coolant circulating line, wherein a first end of the cooling line comes into contact with a second surface of the peltier element and a second end of the cooling line is configured to perform heat exchange between the second end of the cooling line and the second heat exchanger.

16. The non-transitory computer readable medium of claim 14, further comprising:
program instructions that perform a low stage cooling operation, in which the coolant is circulated through the cooling line and the first blower is activated, when a low stage cooling mode has been selected.

17. The non-transitory computer readable medium of claim 14, further comprising:
program instructions that perform a heating operation, in which the peltier element is operated to emit heat from the first surface of the peltier element, and the first blower is activated, when a heating mode has been selected.
